(19) United States
(12) Patent Application Publication
(10) Pub. No.: US 2006/0129664 A1
(43) Pub. Date: Jun. 15, 2006

(54) Method and apparatus for diagnosing a network

(76) Inventors: Scott Reimert, San Jose, CA (US); Carlos Soto, Morgan Hill, CA (US)

Correspondence Address: KAPLAN GILMAN GIBSON & DERNIER L.L.P., 900 ROUTE 9 NORTH, WOODBRIDGE, NJ, 07095, US

(21) Appl. No.: 10/989,216

(22) Filed: Nov. 15, 2004

(51) Int. Cl. G06F 15/173

(52) U.S. Cl. 709/223

(57) ABSTRACT

This invention allows a system to connect to a user's network and query one or more sources in order to access the identity and state of configuration of the computers connected thereto. In a preferred embodiment, the sources are tried in an order to provide the most usable information with the least use of bandwidth and processing power. One example tries the sources in the following order: 1. the active directory, 2. the domain controllers, 2. a range of IP addresses and 4. a specified input file. The methodology allows a service provider to efficiently and automatically assess the state of the entire network, for example, when a new customer subscribes to the service.

### TECHNICAL FIELD

The present invention relates to techniques for diagnosing a network, and more particularly, to a method and system for efficiently and automatically assessing the identity and configuration state of the user computers of a network.

### BACKGROUND OF THE INVENTION

When an administrator of a network needs to diagnose a network having a plurality of user computers, he or she has to obtain the required identity and configuration information of the computers directly from each of the computers. In other words, the administrator has to directly poll each computer for all the desired configuration information of each computer, even though some of the desired information of the user computers is available in centrally located sources such as an active directory, domain controller, etc. Additionally, organized and efficient methods of inventorying all of the computers sequentially, in order to assess their presence and capabilities, do not exist.

The object of the present invention is to provide a method and apparatus for efficiently and automatically acquiring information regarding the configuration of a network and its user computers.

### SUMMARY OF THE INVENTION

To achieve the above object, in an exemplary embodiment, the method of the present invention comprises connecting a diagnosis computer to a network, first ascertaining from one or more known sources on the network an existence of each of a plurality of user computers within the network, and ascertaining a configuration of each user computer, either from the one or more known sources, or from other sources.

Preferably, the plural sources are checked sequentially in an order that the least of the sources and/or the least bandwidth are used for ascertaining the configuration information of the plural user computers of the network.

Preferably, the central sources having some desired information of all the user computers are checked first, and then the individual user computers are checked for remaining information that is not available on the central sources.

If no central source exists, the individual computers may be checked initially. Or, if a central source exists, the individual computers may be inventoried either before or after a central source is checked.

The present invention further provides an apparatus comprising a diagnosis computer, a network, and a plurality of user computers. First software is installed on the diagnosis computer to signal second software installed on the user computers and other sources so as to poll configuration information of the network and the user computers. Preferably, the sources and user computers are checked in an order that minimizes use of the resources of the network.

In a preferred embodiment, the apparatus further comprises a third computer for receiving the polled information directly from the polled sources for analysis and for repairing and/or altering the configuration of the user computers when needed.

With the present invention, the network and the user computers can be efficiently diagnosed, evaluated and re-configured.

### BRIEF DESCRIPTION OF THE DRAWINGS

The above and other features and advantages of the present invention will become clearer after reading the detailed description of the preferred embodiments of the present invention with reference to the accompanying drawings, in which:

FIG. 1 is an illustration of the apparatus of a preferred embodiment according to the present invention; and

FIG. 2 is a block flow illustrating the method according to the present invention.

### DETAILED DESCRIPTION OF THE PREFERRED EMBODIMENTS

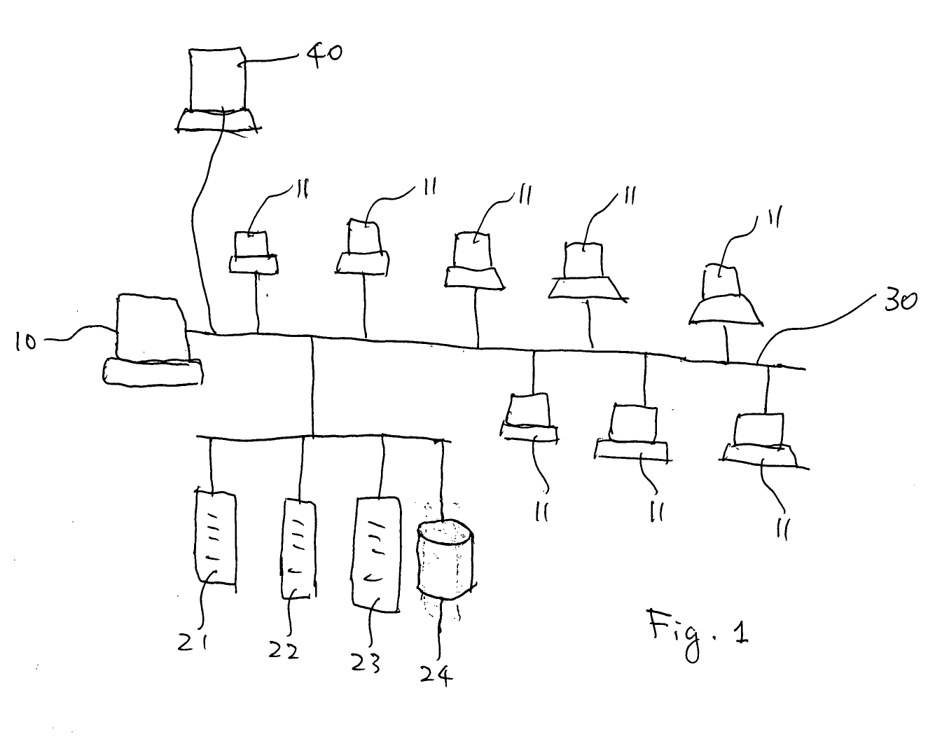

A preferred embodiment of the system according to the present invention is illustrated in FIG. 1, which comprises a diagnosis computer 10 and a network 30 comprising a plurality of user computers 11 and several central sources 21-24. The diagnosis computer 10 may be remotely located from the network 30 and is connectable to the network 30 through a data network connection. The central sources 21-24 may comprises an active directory 21, a domain controller 22, a server 23 responsible for assigning a prescribed range the network addresses for the user computers 11, and a storage 24 that may comprise input files and databases.

According to a preferred embodiment of the present invention, the configuration information of the user computers 11 is first pooled from the central sources 21-24 that may have some configuration information of the user computers 11. For example, the active directory 21 stores information of all the objects on the network, including the names of the user computers 11 and other central sources 22-24. The IP addresses of the user computers 11 are available in the server 23, and identity information of the user computer 11 is available in the domain controller 22, etc.

In a preferred embodiment, the central sources 21-24 are first polled to ascertain the existence of the user computers 11 on the network 30. For example, the identities and the network addresses of the user computers 11 may be ascertained from the domain controller 22. Besides, some information may be available in an input file on the storage 24 or a specified computer, e.g., a computer used by administration personnel.

The configuration information that a diagnosis computer 10 desires to know may include the operating system type, operating system version, virus software, memory amount, disk size, clock speed, etc, of each user computers 11. Preferably, after the user computers 11 are identified, the central sources 21-24 are polled first for these desired configuration information of the user computers 11. After the information available in the central sources 21-24 is obtained, the diagnosis computer 10 then further polls the user computers 11 for additional information that is not available in the central sources 21-24. Such additional information may comprise the configurations for hardware and software in the specific user computers 11.

In a preferred embodiment, the central sources 21-24 are polled for the desired information in a predetermined sequential order. The order may be predetermined in a way that can minimize the use of the processing resources. For example, the order may require use the least numbers of the central sources 21-24 and the user computers 11. A preferred order is that the information is sequentially checked from the active directory 21, assuming this exists in the network, first, then the domain controller 22, then the server 23 for the prescribed range of the network addresses, then the administrator supplied input file in the storage 24, and after all the sources 21-24 are exhausted, individual user computers 11 are polled for remaining information.

Alternatively, the order may be determined in a manner that minimizes use of the bandwidth if the administrator diagnoses the network 30 remotely through a data network connection.

In another embodiment, the polled information from both the central sources 21-24 and the individual user computers 11 are compiled or inventoried by the diagnosis computer 10. The inventory may include a list of each user computer 11 on the network 30 and, for each such user computer 11, a specified list of parameters representing the configurations of each computer 11.

The information may be categorized in a way to show the information sources, which includes the central sources 21-24 and the individual user computers 11, from where the information was obtained. Such a categorization may be helpful in determining a sequential order for future diagnosis polling.

For example, from the history experience provided in the compiled inventory in the diagnosis computer, it can be determined which source should be tried first in the future to maximize the efficiency. Thus, if it is predicted that some information is only available on individual user computers 11, the central sources 21-24 may not need to be polled for this information. Preferably, the polling of the individual user computers 11 for this information does not need to wait after the polling of the central sources 21-24, but instead may be carried out before, or in parallel to, the polling of the information from the central sources 21-24.

In a preferred embodiment, the obtained information is not sent back to the diagnosis computer 10, but to a third computer 40 instead. For example, the polled parameters are sent directly from the central sources 21-24 and user computers 11 to a configuring computer 40 specially for analyzing the polled information against prescribed parameters, and for configuring accordingly the hardware and software on the user computers 11 to be aligned with the prescribed parameters.

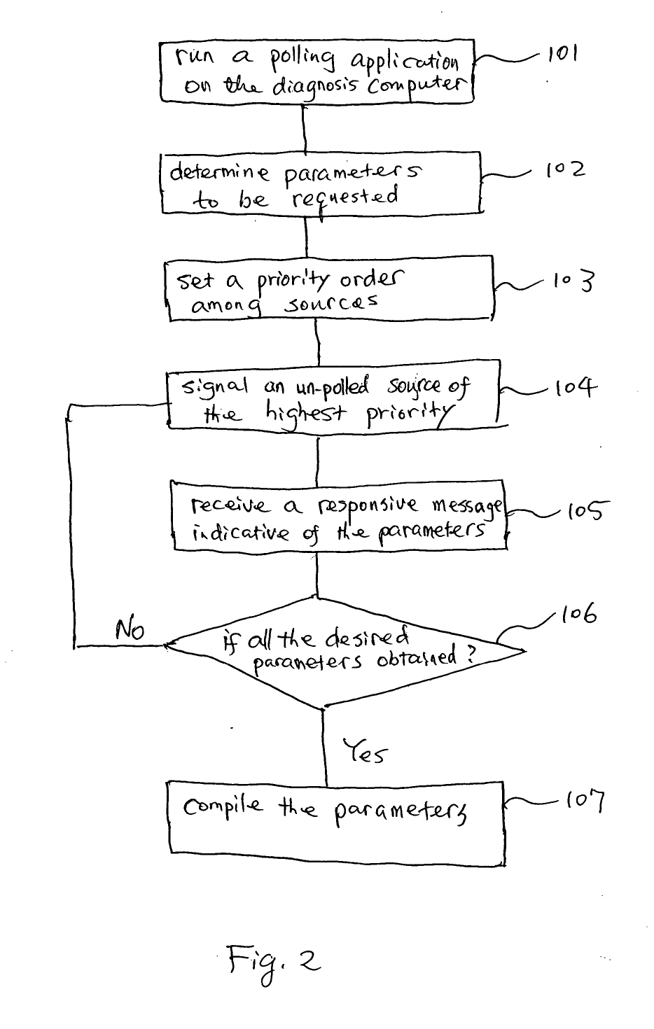

As illustrated in FIG. 2, during the operation, an administrator may running a polling software application installed in the diagnosis computer 11 at step 101 and determines what parameters regarding the configurations of the user computers 11 are to be inquired, at step 102. Then, at step 103, the administrator may decide in which order that the central sources 21-24 and/or the user computers 11 shall be polled. For example, the administrator may select the active directory 21 be polled first if it exists, then the domain controller 22, then the prescribed range of network addresses 23, then the input file 34, etc, and, after all the central sources 21-24 are exhausted and there is still some information unavailable, each of the individual user computers 11 will be polled for remaining information. Although the active directory and domain controllers are both shown for purposes of explanation, in most practical systems, only one or the other would exist for any particular network.

After the setting steps 102 and 103 are finished, the diagnosis computer 10 automatically connects to the source at the highest order (e.g., the active directory 21) and signals it to inquire the desired information, at step 104. As a response, at step 105, a corresponding client software application installed on the inquired source checks the source for the requested information and sends back a message indicative of the required information, i.e., the configuration parameters available in the source. The diagnosis computer 10 stores the obtained information and determines what information is remained unknown and shall be polled from a next source as specified in the prescribed order, at step 106. Then the diagnosis computer signals the next source at step 104 for remaining information, one after another until all the desired information is obtained or all the sources are exhausted. Then the obtained parameters are compiled at step 107.

The above has described in detail the preferred embodiments of the present invention. However, it is appreciated that numerous adaptations, variations and modifications are available to those with ordinary skill in the art without departing from the spirit and scope of the present invention. For example, in an alternative embodiment, the administrator does not give a polling order for specific sources, but only gives a rule for determining the order in which the sources shall be polled. In this case, the polling software will set up the polling order according to the rule decided by the administrator. For example, by configuring the setting of the polling software, the administrator may prescribe that a source that is likely to have most of desired information shall be polled first. After receiving the response from that source, the polling software determines a next source that has the most of the remaining information. Therefore, the scope of the present invention is intended to be solely defined in the accompanying claims.

1. A method comprising connecting a diagnosis computer to a network, first ascertaining, from one or more known sources on said network, an existence of each of a plurality of user computers within said network and ascertaining a configuration of each of said plurality of user computers, either from said one or more known sources, or from other sources.

2. The method of claim one wherein said first ascertaining includes checking plural sources sequentially until a source is found containing information indicative of said configuration of each of said user computers.

3. The method of claim 2 wherein said sequential checking is performed in an order of ascending use of processing resources.

4. The method of claim 2 wherein the sources include at least one of an active directory, domain controllers, a prescribed range of network addresses, and a specified input file.

5. The method of claim 1 further comprising determining hardware and software required to be installed within said user computers to substantially align them with prescribed parameters.

6. The method of claim 5 further comprising compiling a list of each user computer on the network, and for each such user computer, a specified list of parameters.

7. The method of claim 6 wherein said specified list of parameters includes one or more of the following:
operating system type, operating system version, virus software, memory amount, disk size, and clock speed.

8. The method of claim 4 further comprising querying each user computer after its existence is ascertained and requesting each such user computer to transmit its prescribed parameters to said diagnosis computer or to another computer.

9. The method of claim 8 wherein prescribed parameters are sent from said each user computer to said another computer.

10. Apparatus comprising a diagnosis computer, a network, a plurality of user computers, first software within said diagnosis computer, second software within one or more of said user computers, and means for polling the user computers by the diagnosis computer in order to ascertain the version and type of prescribed software within said user computers.

11. Apparatus of claim 10 wherein said prior to polling, said diagnosis computer checks one or more predetermined sources in order to inventory all user computers on the network.

12. Apparatus of claim 11 wherein said predetermined sources are checked in a specified order, said order being designed to minimize resources required for inventorying all said user computers.

13. A method of verifying that a plurality of user computers have all been properly configured comprising the steps of inventorying all such computers, sequentially signaling each such computer over a network, in response to said signaling, receiving a message indicative of configuration parameters of said user computers in the network, and storing information indicative of any user computers from which appropriate configuration parameters have not been received.

14. The method of claim 14 wherein the message received from said user computers includes information indicative of an amount of memory and a version and type of either operating system or virus protection software.
